(19) United States
(12) Patent Application Publication
(10) Pub. No.: US 2012/0061938 A1
(43) Pub. Date: Mar. 15, 2012

(54) Vehicle at Contemporary Stretching and Contraction Action of the Lower and Upper Limbs

(76) Inventor: Luciano Lillo, Bologna (IT)

(21) Appl. No.: 13/321,027

(22) PCT Filed: May 22, 2009
(86) PCT No.: PCT/IB2009/005689

§ 371 Date: Nov. 17, 2011

(51) Int. Cl. B62M 1/00

(52) U.S. Cl. 280/221

(57) ABSTRACT

The vehicle has propulsion generated to the stretching or the contraction of the limbs that push or drag the seat (3) placed on a slide (15) onto guides (16) in one way or in the other. The push is given with the limbs onto the toe-clip device (19) and onto the driving device (20) whereas the traction is actuated dragging the seat (3) with the belt (18). A mechanism (1) is then provided having a connecting rod (2) connected with the seat (3) and with a plate (7) integral with a crown wheel (9) connected by a chain (10) to a sprocket-wheel (11) equipped with a free wheel device (12) and transmitting the motion to the back driving wheels so as to determine the moving of the vehicle.

### FIELD OF THE INVENTION

In the field of the muscular propulsion vehicles different means of transport are known, the motion of whose is given to the action of the limbs onto mechanical devices. In particular pedal devices are known, as for instance the bicycles or similar, in which the push action is alternatively given to a limb or to the other with periodic action. The push to determine the propulsion is generally determined to the action on the pedal of the muscular force of stretching of a leg, with push action distributed over a circumference arc described to the motion of the pedal. This modality of working determines, however, a partial exploitation of the potential of the muscular force of the transport means user, such as is provided the action given alternatively to a single leg. Moreover, the push action in the known means is actuated only onto a circumference arc of the motion transmission device to the kinematic chain.

### SUMMARY OF THE INVENTION

Subject-matter of the invention is a new vehicle able to better exploit the use of the muscular force of the user of the device to produce the motion, with contemporary use of the legs and of the arms and having propulsion push action and traction distributed onto all the circumference of the mechanism determining the circular motion. Other aim reaches to the invention is to have a vehicle that use simultaneously more muscular groups, with advantages for the harmonic development of the muscular masses take up in the motion. Further aim reaches to the invention is to have a vehicle with practical and comfortable use, able to reach good speed of march.

### BRIEF DESCRIPTION OF THE DRAWINGS

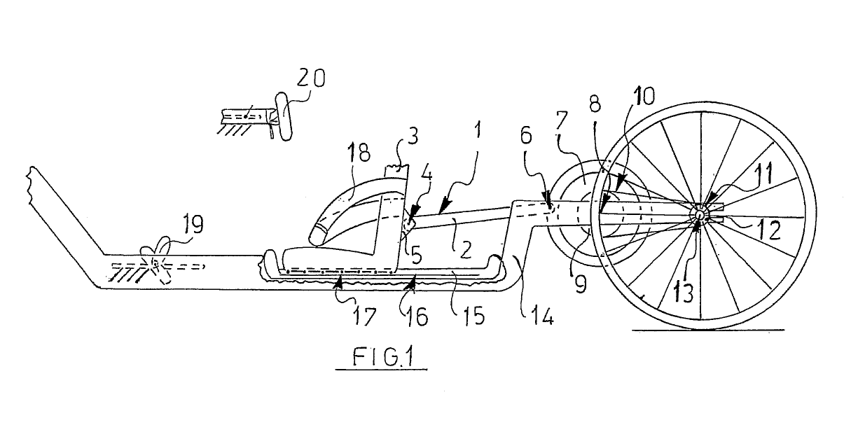

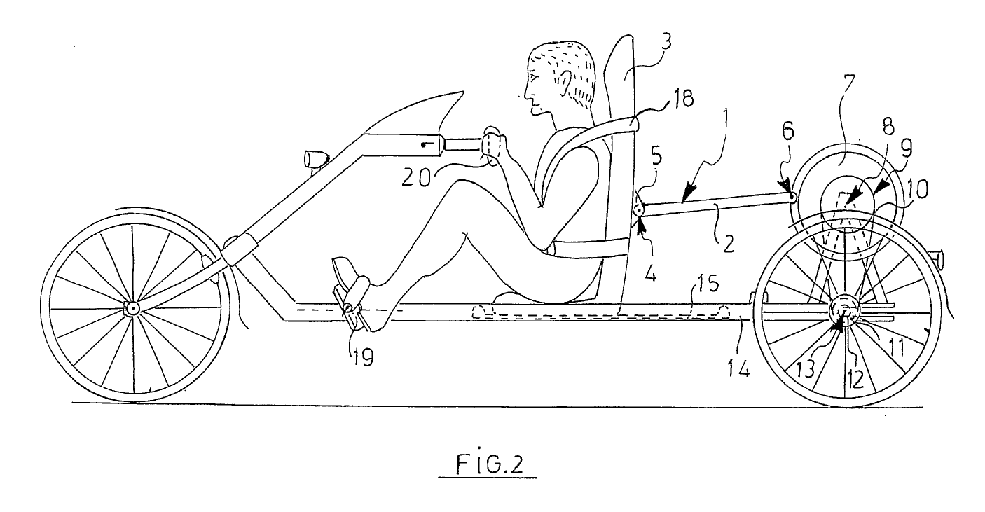

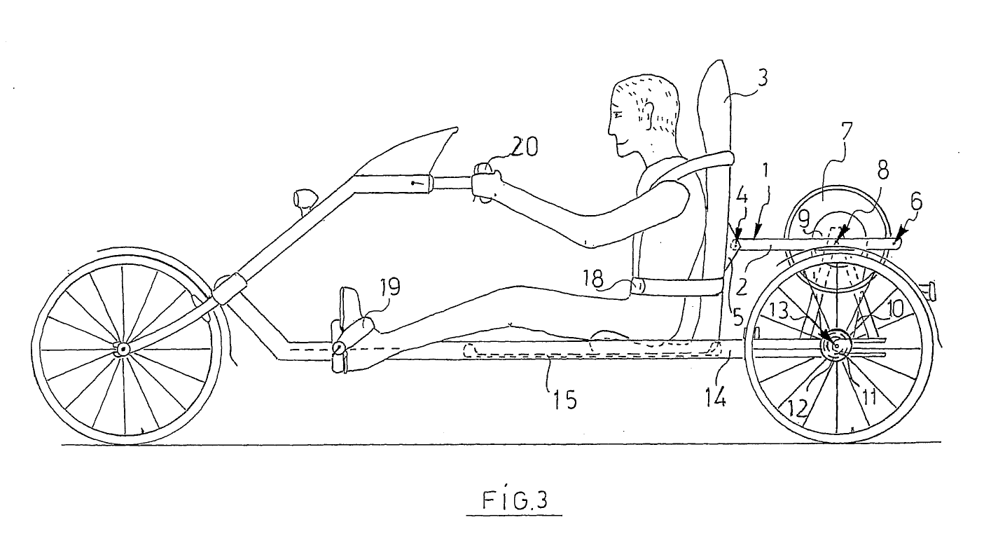

Further characteristics and advantages of the invention will be better understood from the following description of a preferred embodiment but not exclusive also illustrated in an indicative and not limiting way in the drawings of sheets 1, 2 and 3. In particular in sheet 1 FIG. 1 is lateral view of the main parts of the vehicle, i.e. the mechanical parts necessary to the propulsion in horizontal disposition of the kinematic chain. In sheet 2 FIG. 2 is lateral view of the invention with the user of the vehicle at the begin of the stretching phase of the limbs with lateral view of same components of the kinematic chain placed long a vertical axis. In sheet 3 FIG. 3 is lateral view of the begin of the contraction phase of the limbs performed to the user of the transport means.

### DESCRIPTION OF THE PREFERRED EMBODIMENTS

The vehicle with contemporary stretching and contraction action of the lower and upper limbs consists of a mechanism 1 equipped with a connecting rod 2 connected at one of its end with a seat 3 by a pin 4 and support fork of the pin 5, fixed in the outside back part of the seat. At the other end of the connecting rod 2 is connected, by a pin 6, a plate 7. Said plate 7 rotates around a central pin 8. On the same pin rotates and is fixed integral with the plate 7 a crown wheel 9 connected, by chain 10, to a sprocket-wheel 11 with free wheel device 12 and to the back driving wheels. The central pin 8 and the pin 13 of the sprocket-wheel 11 are supported onto a frame 14 positioned onto four wheels. The crown wheel 9, the sprocket-wheel 11 and the chain 10 can to be realized like a transmission, i.e. with more crowns and different sprocket-wheels, on the base of the known art and to be realized to a man skilled in the art. The seat 3 is put onto a slide 15 placed onto guides 16 inside the frame 14 of the vehicle. The guides 16 can be equipped with bearings 17 to make easy the sliding onto the guides.

The seat 3 is, moreover, equipped with a belt 18 to stop the user body at the back of the seat 3. Onto the frame 14 is present, moreover, a toe-clip device 19, to be regulated on the base of the sizes of the legs of the user at the maximum stretching. In the same manner is present onto the invented vehicle a driving device 20 to drive the front wheels to be regulated on the base of maximum extension of the arms. Reserve devices, like the braking device, lighting devices, the direction devices and others to complete the vehicle are arranged on the base of the technics known the art and are easily actuated to a man skilled in the art. In working phase the vehicle provides the contemporary push of arms and legs with stretching of these and the sliding of the seat 3 from the advanced position to the backward position in the way of the back wheels.

The translation motion of the seat 3 is transmitted by the connecting rod 2 to the plate 7 determining its rotation. The crown wheel 9, jointed with the plate 7, is so also it puts in rotation and it transmits the motion by the chain 10 to the sprocket-wheel 11 and to the back driving wheels determining the going on of the vehicle. At the end of stroke of the slide 15 and at the outside dead point of the plate 7 the contraction phase of the limbs begins. The vehicle user by the toe-clip device 19 and the driving device 20 determines the advancement of the slide 15 in opposite way at the motion of the going, with the motion of the seat 3 making easy in the dragging movement in this phase of the of the belt 18.

With the return of the seat in the in initial position the connecting rod 2 drags the plate 7 making complete the rotation and transmitting the motion to the back wheels also in this phase. Periodically repeating the motion with the stretching and the contraction of the limbs the translation motion of the seat is determined in one way and in the other one. This movement is transformed in rotation and in advancement of the vehicle. In the phases in which no push or contraction are actuated to the user and consequently the seat 3 is not moved, the free wheel device 12 permits the motion continuity. The invented device may, of course, be realized in similar embodiments with three or two wheels, having however in these cases less stability. The invented subject-matter has, moreover, the possibility to be used like gymnastic apparatus simply changing the driving wheels with gear wheels for going resistance. The invented subject-matter so created is possible of a lot of modifications and variations, all part of the present inventive concept. All the details, moreover, are to be changed with other technically equivalent.

1.-9. (canceled)

10. A movable vehicle which can be used for contemporaneous stretching and contraction action for the exercise of the lower and upper limbs comprising a seat (3) positioned on a slide (15) placed onto guides (16) carried by a frame (14), said frame (14) being placed onto guides (16) carried by said frame (14), said frame (14) being placed onto at least three wheels and at least two of which are posterior wheels and a crank mechanism (1) provided with a connecting rod (2) connected at one end with the seat (3) by a support fork (5) and a pin (6), a plate (7) rotating around a central pin (8), a crown wheel (9) rotating on the same pin (8) and fixed integrally with the plate (7), said crown wheel (9) being connected by a chain (10) to said sprocket wheel (11), said sprocket wheel (11) having a free wheel device (12) such that a user's simultaneous movement of legs and arms provide or having an extension pushing back the seat (3) on the slide (15) and having a contraction pulling said seat (3) forward by a belt (18), and a toe-clip device (19) holding the legs of the user to determine the motion of the posterior wheels using a thrust distributed on the whole circumference of the crown wheel (9).

11. The vehicle as claimed in claim 10, wherein said frame (14) is placed onto three wheels (9).

12. The vehicle as claimed in claim 10, wherein the vehicle is usable as a stationary gymnastic apparatus and provided with gear wheels for imparting resistance to the gymnastic apparatus.

13. The vehicle as claimed in claim 10, wherein said guides (16) include bearings (17) to facilitate the sliding of guides (16) and seat (3).

14. The vehicle as claimed in claim 10, including coupled with said frame (14) for regulating the base of the size of the legs at the maximum stretching.

15. The vehicle as claimed in claim 10, including driving device (20) for driving the front wheels and regulating the basis of maximum extension of the arms.

16. The vehicle as claimed in claim 10, wherein the central pin (8) and pin (13) for said sprocket wheel (11) are both supported by said frame (14).

17. The vehicle as claimed in claim 10, for stretching and contraction action of the lower and upper limbs, comprising frame (14) which is placed onto four wheels.

18. A vehicle which can be used for contemporaneous stretching and contraction action exercises for lower and upper limbs of a user, comprising:
a frame (14) for supporting and providing a platform for components of the vehicle, and front and a mechanism for supporting said frame;
said frame including a first horizontal frame portion (14A) provided with a slide (15);
a chair mechanism supported by said first horizontal frame portion (14A) and movable horizontally along said slide (15) and being positioned within said frame (14) as the chair moves along said slide (15);
a mechanism (1) for imparting movement to said chair (3) including a connecting rod (12) connected at its first end with the seat (3) and with its second end connected to a rotatable plate (7);
a crown wheel (9) rotatable about a central pin (8) and fixed to said rotatable plate (7), said rotatable plate (7) being rotatable about said central pin (7) together with said crown wheel (9); and
a sprocket wheel (11) and a chain (10) connecting said crown wheel (9) to said sprocket wheel (11).

19. The vehicle as claimed in claim 18, Including
a chair mechanism (3) having a substantially horizontal seat portion and a rear back portion having a front end and a rear end, and a support fork (5) connected with said rear back portion;
said support fork (5) having a first opening for alignment of a first end of said rod (2) with a first opening in a pair of spaced legs of said support fork (5) for alignment with said first opening in the front end of said rod (2) for receiving a pin for coupling said rod (2) with said support fork (5) and said seat (3); and
the second end of said rod (2) having a second opening for connection with a pin (6) fixed to said plate (7).

20. The vehicle as claimed in claim 18, wherein said connecting rod (2) is connected to the outer rim of said plate (7).

21. The vehicle as claimed in claim 18, wherein said toe-clip device (18) and said driving device (20) are adjustable individually or together to determine the extent of the movement of the seat (3) from its central position at the rear end of the vehicle to the front portion of the vehicle.

22. The vehicle as claimed in claim 18, wherein said mechanism for supporting said frame includes at least three wheels, two of such wheels being rear wheels for imparting locomotion to said frame.

23. The vehicle as claimed in claim 18, wherein said supporting mechanism includes gear wheels for imparting resistance without imparting locomotion to the vehicle for use as a stationary gymnastic mechanism.

24. The vehicle as claimed in claim 10, wherein said vehicle can have its front and rear wheels substituted with a wide front wheel and a wide rear wheel substantially centrally positioned along the longitudinal axis of the vehicle in its stationary or movable position and prevent tipping over of the vehicle.

25. The vehicle as claimed in claim 23, at least one of said wheels is a front wheel.
